(19) United States
(12) Patent Application Publication
(10) Pub. No.: US 2021/0123417 A1
(43) Pub. Date: Apr. 29, 2021

(54) WIND TURBINE WASTE HEAT RECOVERY SYSTEM

(71) Applicant: Siemens Gamesa Renewable Energy A/S, Brande (DK)

(72) Inventor: NIKOLA NESIC, VEJLE (DK)

(21) Appl. No.: 16/497,912

(22) PCT Filed: Jan. 24, 2018
(86) PCT No.: PCT/EP2018/051700

§ 371 Date: Sep. 26, 2019

(30) Foreign Application Priority Data
Apr. 3, 2017 (DE) 10 2017 205 636.3

(51) Int. Cl. F03D 9/22; F03D 80/60

(52) U.S. Cl. CPC F03D 9/22; F05B 2260/205; F05B 2220/602; F03D 80/60

(57) ABSTRACT

A waste heat recovery system of a wind turbine is provided. A wind turbine is disclosed, including an electrical installation to transform wind energy into electrical energy, whereby the electrical installation produces waste heat. The wind turbine includes a waste heat recovery system to transform at least a part of the waste heat into electrical energy.

### CROSS-REFERENCE TO RELATED APPLICATIONS

This application claims priority to PCT Application No. PCT/EP2018/051700, having a filing date of Jan. 24, 2018, which is based on German Application No. 10 2017 205 636.3, having a filing date of Apr. 3, 2017, the entire contents both of which are hereby incorporated by reference.

### FIELD OF TECHNOLOGY

The following relates to a waste heat recovery system of a wind turbine.

### BACKGROUND

In a wind turbine the energy of moving air is transformed into electrical energy. A wind turbine comprises a rotor that is connected to an electrical generator. The power generated by the electrical generator is transformed by a converter and a transformer system to adapt the electrical power to fit to the conditions of a power grid.

In addition, a wind turbine comprises various control systems and auxiliary systems like systems for cooling, dehumidifying, hydraulic, or pumps for lubrication, for example.

During the generation of electric energy, a certain amount of energy is transferred into waste heat. In addition, the systems for conversion or the electrical energy and the secondary systems necessary to operate the wind turbine, create waste heat.

The waste heat is mainly transferred to the ambient air or sea water around the wind turbine by heat exchangers and radiators.

A certain percentage of the power of the wind turbine is lost as waste heat to the environment.

### SUMMARY

An aspect relates to a wind turbine with increased efficiency.

A wind turbine is disclosed, comprising an electrical installation to transform wind energy into electrical energy, whereby the electrical installation produces waste heat.

The wind turbine comprises a waste heat recovery system to transform at least a part of the waste heat into electrical energy.

A waste heat recovery system is installed in the wind turbine to use the waste heat of components of the wind turbine and transfer the thermal energy into electrical energy.

Thus, the efficiency of the wind turbine can be increased.

Electrical installations in the wind turbine that produce waste heat are a generator, a transformer, or a converter, for example.

Waste heat is thermal energy generated as a by-product in systems, whereby the thermal energy is un-wanted, and reduces the efficiency of the wind turbine.

A waste heat recovery system is using the un-wanted thermal energy to transform it into a form of energy that can be used in the wind turbine to increase the efficiency, like electrical energy, for example.

The wind turbine comprises a cooling system with a cooling circuit to cool the electrical installation that produces waste heat. The waste heat recovery system is connected to the cooling circuit of the wind turbine in a way that thermal energy is transferred from the cooling circuit to the waste heat recovery system.

Electrical installations are often cooled by cooling systems, to remove the un-wanted thermal energy. The cooling system has a cooling circuit. The cooling circuit can be a liquid filled cooling circuit or an air filled cooling circuit. The cooling system collects the thermal energy and transports it to a heat sink.

The waste heat recovery system is connected to the cooling circuit of the cooling system, so that the thermal energy is transferred to the waste heat recovery system.

The heat can be transferred to the waste heat recovery system by a heat exchanger, for example, whereby a first circuit of the heat exchanger is connected to the cooling system and a second circuit of the heat exchanger is connected to the waste heat recovery system.

The waste heat recovery system comprises a fluid circuit to transport thermal energy. The thermal energy of the cooling circuit of the wind turbine is transferred to a fluid in the fluid circuit of the waste heat recovery system.

The waste heat recovery system comprises a turbine to expand the fluid in the circuit of the waste heat recovery system, and to transform thermal energy of the fluid into rotational energy of the turbine.

The waste heat recovery system comprises a waste heat recovery generator to transform the rotational energy of the turbine into electrical energy.

The fluid in the circuit of the waste heat recovery system is heated by the waste heat of the electrical installations. The fluid can be a liquid or a gas under high pressure, that is in a liquid state.

The fluid of the waste heat recovery system is evaporated. The evaporated fluid is guided through a turbine, for example a steam turbine, where the energy of the fluid is transformed into rotational energy of the turbine.

An electrical generator is connected to the shaft of the turbine of the waste heat recovery system, so that the rotational energy of the turbine can be transferred into electrical energy.

The fluid circuit of the waste heat recovery system comprises a fluid, whereby the boiling temperature of the fluid is below 100° C.

The fluid used in the cooling system for the electrical installations of the wind turbine may comprise water or oil, for example, as a cooling liquid. The temperature of the liquid in this cooling circuit is kept below the temperature where the liquid would transform into steam. Thus, for oil below the boiling temperature of the respective oil, which might be above 200° C., or for water below 100° C.

The fluid used in the cooling system for the electrical installations of the wind turbine may be a gas, for example air. Also, the gas as a cooling fluid is kept below a certain maximum temperature.

Thus, the fluid of the waste heat recovery system is heated to a temperature below 100° C. To allow the turbine of the waste heat recovery system to operate, steam needs to be generated at a temperature below 100° C.

By selecting a respective fluid, the waste heat recovery system can be operated in a wind turbine with a, for example, water operated cooling system of the electrical installations.

The boiling temperature of the fluid is below 80° C. and above 20° C.

A certain temperature difference between the fluid in the cooling system of the electrical installations and the waste heat recovery system is needed to heat the fluid of the waste heat recovery system and evaporate it.

Thus, it is advantageous to select the fluid for the waste heat recovery system in a way that the boiling temperature of the fluid is below 80° C.

It should be above 20° C. to allow the fluid to condense under normal ambient temperatures, thus extra cooling of the fluid is avoided.

The fluid is an organic liquid, and the process to transform the thermal energy into electrical energy is employing an Organic Rankine Cycle.

Organic fluids are known, that show the properties necessary to be used in a waste heat recovery system. The cycle used in the waste heat recovery system is an Organic Rankine Cycle, for example.

The waste heat recovery system comprises an evaporator to evaporate the fluid by the thermal energy transferred from the cooling circuit of the wind turbine.

Thermal energy of the cooling system of the electrical installations of the wind turbine is used to heat the organic liquid in the evaporator.

The gas is then used to accelerate the steam turbine present in the waste heat recovery system.

The waste heat recovery system comprises a condenser, to condense the fluid and to extract thermal energy from the fluid in the circuit.

After the fluid leaves the steam turbine of the waste heat recovery system, the fluid is cooled down to condensate again. A part of the thermal energy present in the fluid is removed, the fluid is cooled until the fluid completely condensed into a liquid again.

The fluid in its liquid form is them reused in the waste heat recovery system.

The waste heat recovery system comprises a pump to move the fluid in the fluid circuit of the waste heat recovery system.

The pump accelerates the fluid in its liquid form though the waste heat recovery system.

The fluid is carbon dioxide, and the process to transform the thermal energy into electrical energy is employing a Carbon Transcritical Power Cycle.

Carbon dioxide is used as a fluid in the waste heat recovery system. The carbon dioxide is hold under pressure in the waste heat recovery system to be in a liquid state when entering the heat exchanger.

Carbon dioxide can then be evaporated at temperatures below 100° C., preferably below 80° C. Carbon dioxide is easily available in nature, and will not harm the wind turbine or technicians present in the wind turbine in case of a failure and leakage.

The waste heat recovery system comprises a first heat exchanger that connects the cooling system of the wind turbine and the fluid circuit of the waste heat recovery system to transfer thermal energy from the cooling system to the fluid circuit.

The thermal energy is transferred from the fluid of the cooling system to the fluid of the waste heat recovery system in a heat exchanger. The carbon dioxide is heated and evaporated to create a gas to be used in the waste heat recovery cycle.

The waste heat recovery system comprises a second heat exchanger, to transfer heat from the fluid after the exit of the turbine in flow direction of the fluid, to the fluid before the entrance of the first heat exchanger, to re-use the thermal energy present in the fluid circuit.

After the carbon dioxide leaves the turbine, it still comprises thermal energy. The carbon dioxide is then cooled to condensate. The condensed carbon dioxide is then returned to the heat exchanger though a pump.

A second heat exchanger is used in the cycle to transfer remaining heat from the fluid that leaves the turbine to the fluid before it enters the first heat exchanger, to preheat the fluid.

The first heat exchanger transfers the waste heat of the cooling system of the electrical installations to the fluid of the waste heat recovery system.

Thus, even more remaining heat is reused, and the efficiency of the wind turbine is increased.

The wind turbine comprises a rotor and a wind turbine electrical generator that is connected to the rotor in a way that the rotational energy of the rotor is transferred to the electrical generator to transform wind energy into electrical energy, and the cooling system of the wind turbine cools the wind turbine electrical generator.

The electrical generator of the wind turbine is the major source of waste heat.

The waste heat of the electrical generator is reused to generate additional electrical energy. Thus, the efficiency of the wind turbine is increased.

The wind turbine comprises a nacelle, and the waste heat recovery system is located in the nacelle.

Thus, the waste heat recovery system is arranged close to electrical installations creating waste heat, like the generator, the transformer, or electrical cabinets.

In addition, the waste heat recovery system can easily be accessed by service technicians for service and maintenance.

The nacelle comprises a housing, and thermal energy of the condenser of the waste heat recovery system is transferred to the environmental air by a cooler that is connected to the outside of the housing of the nacelle.

The fluid in the waste heat recovery system needs to be cooled to be condensed. A cooler is arranged outside the nacelle, to remove remaining waste heat. Ambient air cools the cooler, the ambient air moves along the cooler, when the wind blows, and the wind turbine is in operation.

Thus, ambient air is very efficient in cooling the fluid when the system is in operation.

### BRIEF DESCRIPTION

Some of the embodiments will be described in detail, with references to the following Figures, wherein like designations denote like members, wherein:

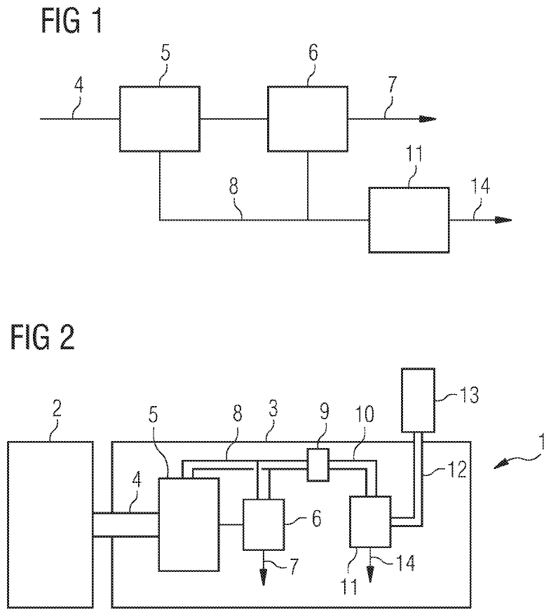

FIG. 1 shows a wind turbine comprising a waste heat recovery system;

FIG. 2 shows a detailed embodiment of a wind turbine with a waste heat recovery system;

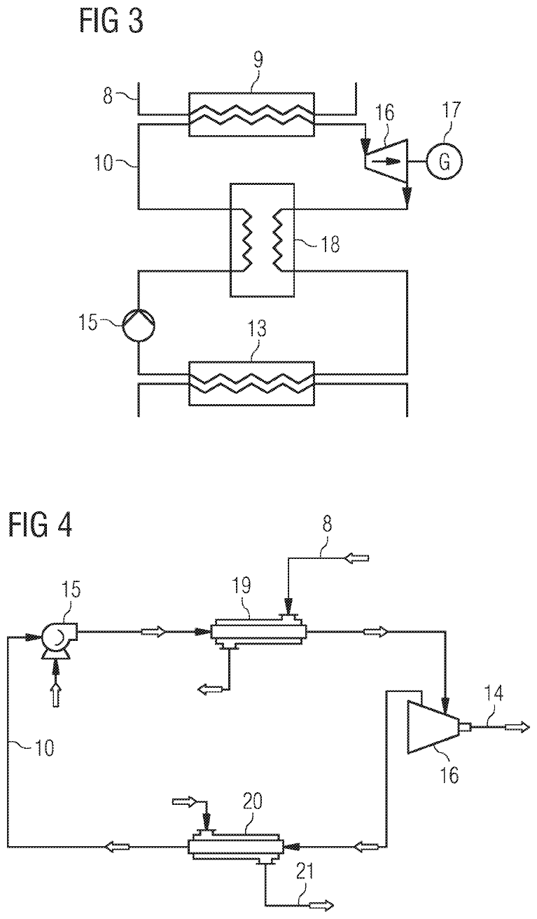

FIG. 3 shows a detailed view of the waste heat recovery system; and

FIG. 4 shows an alternative embodiment of a waste heat recovery system.

### DETAILED DESCRIPTION

FIG. 1 shows a wind turbine comprising a waste heat recovery system.

FIG. 1 shows a wind turbine comprising a waste heat recovery system 11.

A wind turbine transforms rotational energy into electrical energy. Therefore, a shaft 4 is connected to an electrical generator 5. The electrical energy from the generator 5 is transformed in a converter or transformer 6 to achieve the electrical energy output 7 that is needed.

The electrical installations 5, 6 are cooled by a cooling system 8, using a liquid or air, for example. The cooling system is connected to the waste heat recovery system 11 that transforms the thermal energy of the cooling system 8 into electrical energy 14.

Thus, the waste heat of the electrical installations 5, 6 is used to generate additional electrical energy.

FIG. 2 shows a detailed embodiment of a wind turbine with a waste heat recovery system.

The wind turbine 1 comprises a hub 2 and a nacelle 3. A rotor blade is connected to the hub 2 and the wind interacts with the rotor blade to cause a rotation of the hub 2 in respect to the nacelle 3. The rotation of the hub 2 is transferred by a shaft 4 to an electrical generator 5.

The electrical energy from the generator 5 is transferred to other electrical installations 6 to transform the electrical energy into the output power 7 needed. The electrical installations 5, 6 are cooled by a cooling circuit 8.

The cooling circuit 8 is connected by a heat exchanger 9 to the fluid circuit 10 of the waste heat recovery system 11. The waste heat recovery system 11 transforms the thermal energy transferred from the cooling system 8 into electrical energy 14.

A part of the remaining waste heat is transferred by a cooling circuit 12 to a cooler 13 that is arranged in a way that it can be cooled by environmental air in the vicinity of the nacelle 3 or by sea water.

FIG. 3 shows a detailed view of the waste heat recovery system.

The waste heat recovery system comprises a fluid circuit 10. The fluid in the fluid circuit 10 is carbon dioxide, for example.

A pump 15 moves the fluid in the fluid circuit 10. Waste heat is transferred to the waste heat recovery system by a cooling circuit 8 and a heat exchanger 9. The fluid in the fluid circuit 10 is heated by the thermal energy transferred from the cooling circuit 8.

The waste heat evaporates the fluid in the fluid circuit 10. The steam created in the heat exchanger 9 is expanded in a turbine 16. The thermal energy of the steam in the fluid circuit 10 is transformed into rotational energy of the turbine 16.

The rotational energy of the turbine 16 is transformed into electrical energy by the generator 17 of the waste heat recovery system.

The expanded steam of the cooling circuit 10 is condensed in a condenser 13. Thus, a part of the remaining thermal energy of the fluid in the fluid circuit 10 is removed by cooling the fluid.

The fluid then flows through the pump 15 towards the evaporator 9.

An additional internal heat exchanger 18 is present in the fluid circuit 10 to transfer a part of the remaining thermal energy of the steam after the expanded steam leaves the turbine 16 to the condensed fluid before it enters the evaporator 9.

The condenser 13 can be cooled by air, by sea water, or by an additional cooling circuit.

FIG. 4 shows an alternative embodiment of a waste heat recovery system.

The waste heat recovery system comprises a fluid circuit 10. The fluid and the fluid circuit 10 is an organic liquid and the waste heat recovery system is using an Organic Rankine Cycle.

The pump 15 is present in the fluid circuit 10 to move the liquid in the fluid circuit. The fluid enters an evaporator 19, the waste heat is transferred by a cooling circuit 8 to the evaporator and is used to evaporate the liquid.

The steam of the organic liquid is expanded in a turbine 16. The thermal energy of the fluid in the fluid circuit 10 is transformed into rotational energy of the turbine 16 and into electrical energy 14 by a generator connected to the turbine 16.

The expanded steam of the fluid is condensed in a condenser 20. A part of the remaining thermal energy is removed from the fluid. The condenser 20 can be cooled by ambient air or by an additional cooling circuit removing the thermal energy 21.

After being condensed in the condenser 20, the fluid comes back to the pump 15 and returns to the evaporator 19.

The illustration in the drawings is in schematic form. It is noted that in different figures, similar or identical elements are provided with the same reference signs.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A wind turbine comprising:
an electrical installation to transform wind energy into electrical energy, whereby the electrical installation produces waste heat; and
a waste heat recovery system to transform at least a part of the waste heat into electrical energy.

2. The wind turbine according to claim 1, comprising a cooling system with a cooling circuit to cool the electrical installation that produces waste heat, whereby the waste heat recovery system is connected to the cooling circuit of the wind turbine in a way that thermal energy is transferred from the cooling circuit to the waste heat recovery system.

3. The wind turbine according to claim 2, wherein the waste heat recovery system comprises:
a fluid circuit to transport thermal energy, wherein the thermal energy of the cooling circuit of the wind turbine is transferred to a fluid in the fluid circuit of the waste heat recovery system;
a turbine to expand the fluid in the fluid circuit of the waste heat recovery system, and to transform thermal energy of the fluid into rotational energy of the turbine; and
a waste heat recovery generator to transform the rotational energy of the turbine into electrical energy.

4. The wind turbine according to claim 3, wherein the fluid circuit of the waste heat recovery system comprises a fluid, and a boiling temperature of the fluid is below 100° C.

5. The wind turbine according to claim 4, wherein the boiling temperature of the fluid is below 80° C. and above 20° C.

6. The wind turbine according to claim 3, wherein the fluid is an organic liquid, and a process to transform the thermal energy into electrical energy is employing an Organic Rankine Cycle.

7. The wind turbine according to claim 6, wherein the waste heat recovery system comprises an evaporator to evaporate the fluid by the thermal energy transferred from the cooling circuit of the wind turbine.

8. The wind turbine according to claim 6, wherein the waste heat recovery system comprises a condenser to condense the fluid and to extract thermal energy from the fluid in the fluid circuit.

9. The wind turbine according to claim 6, wherein the waste heat recovery system comprises a pump to move the fluid in the fluid circuit of the waste heat recovery system.

10. The wind turbine according to claim 3, wherein the fluid is carbon dioxide, and a process to transform the thermal energy into electrical energy is employing a Carbon Transcritical Power Cycle.

11. The wind turbine according to claim 10, wherein the waste heat recovery system comprises a first heat exchanger that connects the cooling circuit of the wind turbine and the fluid circuit of the waste heat recovery system to transfer thermal energy from the cooling system to the fluid circuit.

12. The wind turbine according to claim 11, wherein the waste heat recovery system comprises a second heat exchanger, to transfer heat from the fluid after an exit of the turbine in a flow direction of the fluid, to the fluid before an entrance of the first heat exchanger, to re-use the thermal energy present in the fluid circuit.

13. The wind turbine according to claim 2, wherein the wind turbine comprises a rotor and a wind turbine electrical generator that is connected to the rotor in a way that a rotational energy of the rotor is transferred to the electrical generator to transform wind energy into electrical energy, and the cooling circuit of the wind turbine cools the wind turbine electrical generator.

14. The wind turbine according to claim 1, wherein the wind turbine comprises a nacelle, and the waste heat recovery system is located in the nacelle.

15. The wind turbine according to claim 14, wherein the nacelle comprises an housing, and thermal energy of a condenser of the waste heat recovery system is transferred to environmental air by a cooler that is connected to an outside of the housing of the nacelle.
